(19) United States
(12) Patent Application Publication
(10) Pub. No.: US 2026/0281504 A1
(43) Pub. Date: Sep. 17, 2026

(54) MEDIA RECOMMENDATION

(71) Applicant: TENCENT TECHNOLOGY (SHENZHEN) COMPANY LIMITED, Shenzhen (CN)

(72) Inventors: Haohan CHI, Shenzhen (CN); Zhenhong ZHANG, Shenzhen (CN); Shaoming WANG, Shenzhen (CN); Jinming ZHANG, Shenzhen (CN)

(73) Assignee: TENCENT TECHNOLOGY (SHENZHEN) COMPANY LIMITED, Shenzhen (CN)

(21) Appl. No.: 19/665,360

(22) Filed: May 1, 2026

Related U.S. Application Data
(63) Continuation of application No. PCT/CN2025/099913, filed on Jun. 9, 2025.

(30) Foreign Application Priority Data
Jul. 25, 2024 (CN) 202411009999.6

(51) Int. Cl. H04N 21/466; H04N 21/44

(52) U.S. Cl. CPC H04N 21/4668; H04N 21/44008

(57) ABSTRACT

An interaction feature set between an object set and a media set is obtained. The interaction feature set is generated based on historical media transaction records of objects in the object set. The interaction feature set is decomposed into an object feature set and a media feature set. From the media set and for a target object in the object set, one or more target media that have no interaction with the target object are obtained. A target object feature of the target object is obtained from the object feature set. Respective target media features of the one or more target media are obtained from the media feature set. Transaction matching degrees between the target object and the one or more target media are determined. Based on the transaction matching degrees, one or more recommended media to be recommended to the target object are determined.

### RELATED APPLICATIONS

The present application is a continuation of International Application No. PCT/CN2025/099913, filed on Jun. 9, 2025, which claims priority to Chinese Patent Application No. 202411009999.6, filed on Jul. 25, 2024. The entire disclosures of the prior applications are hereby incorporated by reference.

### FIELD OF THE TECHNOLOGY

This disclosure relates to the field of computer technologies, including a media recommendation method and apparatus, a computer device, a storage medium, and a computer program product.

### BACKGROUND OF THE DISCLOSURE

With the development of computer technologies, people are exposed to more and more types of media, such as videos, music, articles, and graphic and textual information, in daily life. In addition, a recommendation function also appears on the Internet. For example, in a video application, a video in which a user may be interested is recommended to the user. The recommendation function supports personalized recommendations for users.

In a related technology, media recommendations are usually based on the user side or the media side. For the user side, media recommendations are usually based on user similarity, that is, a user recommended media that users similar to the user have interacted with. For the media side, a media recommendation is usually performed based on a media similarity, that is, a user is recommended other media similar to the media that the user has interacted with. However, currently, such media recommendation methods are based on only the user side or the media side and have limitations, resulting in low media recommendation effectiveness.

### SUMMARY

Embodiments of this disclosure include a media recommendation method and apparatus, a computer device, a computer-readable storage medium (e.g., non-transitory computer-readable storage medium), and a computer program product that can improve media recommendation effectiveness.

Some aspects of the disclosure provide a method of media recommendation. In some examples, an interaction feature set between an object set and a media set is obtained. The interaction feature set is generated based on historical media transaction records of objects in the object set, and the historical media transaction records include item transaction records of the objects on media in the media set. The interaction feature set is decomposed into an object feature set associated with the object set and a media feature set associated with the media set. From the media set and for a target object in the object set, one or more target media that have no interaction with the target object are obtained. A target object feature of the target object is obtained from the object feature set. Respective target media features of the one or more target media are obtained from the media feature set. Based on the target object feature of the target object and the target media features of the one or more target media, respective transaction matching degrees between the target object and the one or more target media are determined. Based on the transaction matching degrees and from the one or more target media, one or more recommended media to be recommended to the target object are determined.

Some aspects of the disclosure provide an apparatus for media recommendation. The apparatus includes processing circuitry configured to obtain an interaction feature set between an object set and a media set. The interaction feature set is generated based on historical media transaction records of objects in the object set, and the historical media transaction records include item transaction records of the objects on media in the media set. The processing circuitry is also configured to decompose the interaction feature set into an object feature set associated with the object set and a media feature set associated with the media set. The processing circuitry is configured to obtain, from the media set and for a target object in the object set, one or more target media that have no interaction with the target object. Further, the processing circuitry is configured to obtain a target object feature of the target object from the object feature set. The processing circuitry is configured to obtain respective target media features of the one or more target media from the media feature set. The processing circuitry is configured to determine, based on the target object feature of the target object and the target media features of the one or more target media, respective transaction matching degrees between the target object and the one or more target media. Further, the processing circuitry is configured to determine, based on the transaction matching degrees and from the one or more target media, one or more recommended media to be recommended to the target object.

Some aspects of the disclosure provide a non-transitory computer-readable storage medium storing instructions which when executed by at least one processor cause the at least one processor to perform any of the methods of media recommendation described herein.

This disclosure provides a media recommendation method, performed by a computer device and including: obtaining an interaction feature set between an object set and a media set, the interaction feature set being a set generated based on historical media transaction records of objects in the object set, and the historical media transaction records being item transaction records of the objects for recommended items corresponding to historical interaction media; decomposing the interaction feature set into an object feature set corresponding to the object set and a media feature set corresponding to the media set; determining a target object from the object set, obtaining, from the media set, media with which the target object has not interacted as target media, obtaining a target object feature of the target object from the object feature set, and obtaining target media features of the target media from the media feature set; determining, based on the target object feature and the target media features, transaction matching degrees between the target object and the target media; and determining, based on the transaction matching degrees, recommended media corresponding to the target object from the target media.

This disclosure further provides a media recommendation apparatus, including: an interaction feature set obtaining module, configured to obtain an interaction feature set between an object set and a media set, the interaction feature set being a set generated based on historical media transaction records of objects in the object set, and the historical media transaction records being item transaction records of the objects for recommended items corresponding to historical interaction media; an interaction feature set decomposition module, configured to decompose the interaction feature set into an object feature set corresponding to the object set and a media feature set corresponding to the media set; a target feature determining module, configured to determine a target object from the object set, obtain, from the media set, media with which the target object has not interacted as target media, obtain a target object feature of the target object from the object feature set, and obtain target media features of the target media from the media feature set; a transaction matching degree determining module, configured to determine, based on the target object feature and the target media features, transaction matching degrees between the target object and the target media; and a recommended media determining module, configured to determine, based on the transaction matching degrees, recommended media corresponding to the target object from the target media.

This disclosure further provides a computer device, including a memory and a processor (an example of processing circuitry), the memory having computer-readable instructions stored therein, the processor, when executing the computer-readable instructions, being configured for implementing the operations in the foregoing media recommendation method.

This disclosure further provides a non-transitory computer-readable storage medium, having computer-readable instructions stored therein, where when the computer-readable instructions are executed by a processor, the operations in the foregoing media recommendation method are implemented.

This disclosure further provides a computer program product, including computer-readable instructions, where when the computer-readable instructions are executed by a processor, the operations in the foregoing media recommendation method are implemented.

### BRIEF DESCRIPTION OF THE DRAWINGS

FIG. 1 is a diagram of an application environment of a media recommendation method according to an embodiment.

FIG. 2 is a schematic flowchart of a media recommendation method according to an embodiment.

FIG. 3 is a schematic diagram of decomposing an interaction matrix according to an embodiment.

FIG. 4 is a schematic flowchart of a media recommendation method according to another embodiment.

FIG. 5 is a schematic diagram of data processing of a target matching model according to an embodiment.

FIG. 6 is a schematic flowchart of training a matching model according to an embodiment.

FIG. 7 is a schematic flowchart of a media recommendation method according to another embodiment.

FIG. 8 is a schematic flowchart of a media recommendation method according to another embodiment.

FIG. 9 is a schematic flowchart of a media recommendation method according to another embodiment.

FIG. 10 is a schematic diagram of an interface of a short video platform according to an embodiment.

FIG. 11 is a structural block diagram of a media recommendation apparatus according to an embodiment.

FIG. 12 is an internal structure diagram of a computer device according to an embodiment.

FIG. 13 is an internal structural diagram of a computer device according to another embodiment.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

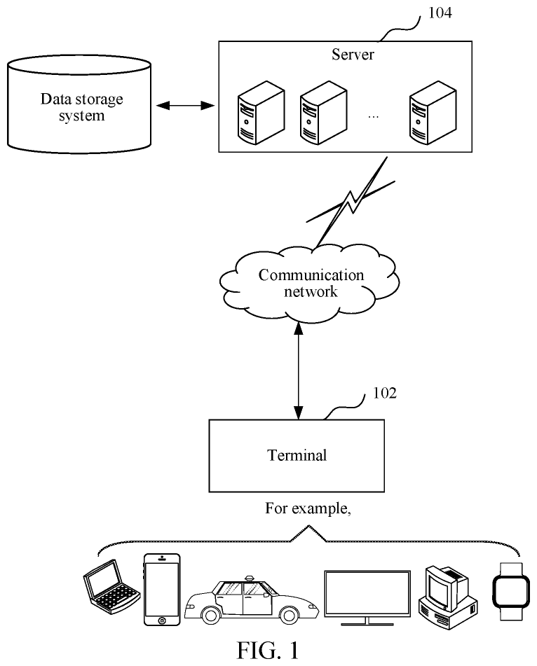

A media recommendation method provided in an embodiment of this disclosure may be applied to an application environment shown in FIG. 1. In the figure, a terminal 102 communicates with a server 104 through a network. A data storage system may store data the server 104 needs to process. A data storage system may be separately disposed, may be integrated on the server 104, or may be placed on a cloud or another device. The terminal 102 may be, but is not limited to, various personal computers, notebook computers, smartphones, tablet computers, Internet of Things devices, or portable wearable devices. The Internet of Things device may be a smart speaker, a smart television, a smart air conditioner, a smart in-vehicle device, or the like. The portable wearable device may be a smartwatch, a smart band, a head mounted device, or the like. The server 104 may be implemented by using an independent server, a server cluster including a plurality of servers, or a cloud server.

The terminal and the server may be separately configured to perform the media recommendation method provided in the embodiments of this disclosure. The terminal and the server may alternatively be configured to jointly perform the media recommendation method provided in the embodiments of this disclosure.

For example, the server obtains an interaction feature set between an object set and a media set, and decomposes the interaction feature set into an object feature set corresponding to the object set and a media feature set corresponding to the media set. The interaction feature set is generated based on historical media transaction records of objects in the object set, and the historical media transaction records are item transaction records for recommended items corresponding to historical interaction media. The server determines a target object from the object set, obtains, from the media set, media with which the target object has not interacted as target media, obtains a target object feature of the target object from the object feature set, and obtains target media features of the target media from the media feature set. The server determines, based on the target object feature and the target media features, transaction matching degrees between the target object and the target media, and determines, based on the transaction matching degrees, recommended media corresponding to the target object from the target media.

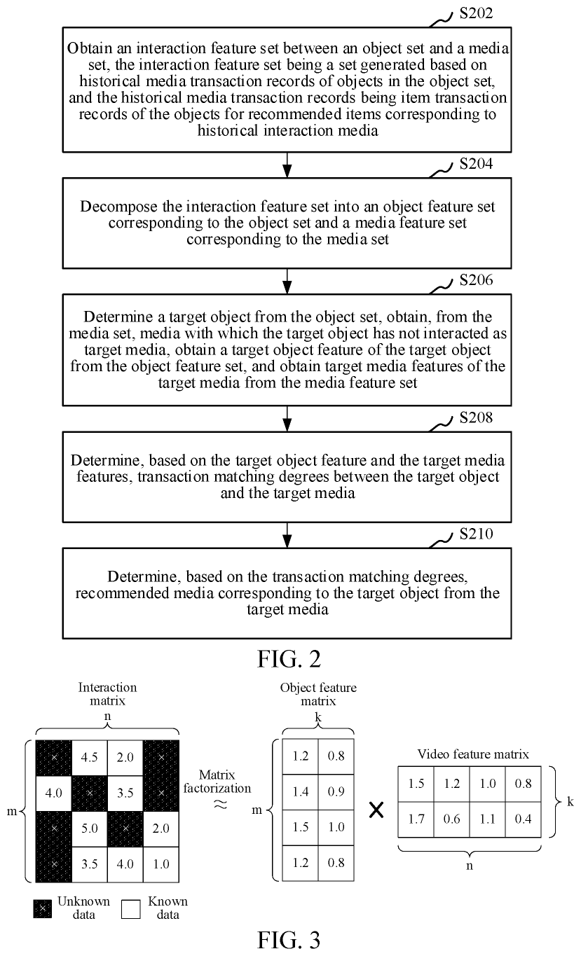

In an embodiment, as shown in FIG. 2, a media recommendation method is provided. An example in which the method is applied to a computer device is used for description. The computer device may be a terminal or a server. The method may be performed by the terminal or the server separately, or may be implemented through interaction between the terminal and the server. In the method:

Operation S202: Obtain an interaction feature set between an object set and a media set, the interaction feature set being a set generated based on historical media transaction records of objects in the object set, and the historical media transaction records being item transaction records of the objects for recommended items corresponding to historical interaction media.

The object set includes a plurality of objects. The object refers to a user. The media set includes a plurality of media. The media refer to content presented in at least one media form (such as a text, a picture, a video, or audio). For example, the media may be a video, graphic and textual information, audio, an article, or the like.

The interaction feature set between an object set and a media set includes interaction features between the plurality of objects in the object set and the plurality of media in the media set. The interaction feature set is a set generated based on historical media transaction records of objects in the object set. The historical media transaction records of the objects are item transaction records of the objects for recommended items corresponding to historical interaction media. The historical interaction media of the object refers to media with which the user has interacted. For example, if the media is a video, the historical interaction media of the object may be a video watched by the user, a video liked by the user, a video commented by the user, a video shared by the user, or the like. In a process in which the user browses media, an item may be recommended to the user. The recommended item corresponding to the media refers to an item recommended by using the media. The recommended item corresponding to the media may be an item included in the media. For example, if the media is an item advertisement, the item corresponding to the media is an item advertised by the media. The recommended item corresponding to the media may be an item presented in association with the media. For example, the recommended item corresponding to the media may be an item presented with a corresponding item transaction entrance in a media presentation interface. The item transaction entrance corresponding to the item is an entrance configured for triggering a transaction for the item. For example, the item transaction entrance may be an item purchase control. If the media is a video, the item purchase control is presented in a video presentation interface, and the user may purchase a corresponding item by using the item purchase control. An item transaction record of an object for an item is a record generated after the object trades for the item. For example, an item transaction record of an object for an item is a consumption record of the object for the item. The item transaction record is configured for recording transaction information of an item transaction. For example, the item transaction record includes data such as a transaction time, a transaction amount, a transaction channel, and a transaction platform. The historical interaction media belongs to the media set, the historical interaction media of an object is media that has interacted with the object, the historical interaction media has a corresponding recommended item, and the historical media transaction record of the object is an item transaction record of the object for the corresponding recommended item (the recommended item corresponding to the historical interaction media). For example, if a user A has watched a video B, and a recommended item corresponding to the video B is an item C, a historical media transaction record of the user A includes an item transaction record of the user for the item C.

An item may be a physical item such as costume or food, or an item may be a virtual item such as a service or a virtual prop. The virtual prop may be a social prop (such as an emotion, a background, or a bubble), a game prop (such as an instrument, equipment, or a pet), or the like.

For any object in the object set, the media set may include media with which the object has interacted, or may include media with which the object has not interacted. For media with which the object has interacted, an interaction feature between the object and the media is generated based on a related transaction record of an item recommended to the object for the media with which the object has interacted. For example, if the media is a video, for a video B watched by a user A, an interaction feature between the user A and the video B is generated based on an item transaction record of the user A for a recommended item corresponding to the video B. For media with which the object has not interacted, an interaction feature between the object and the media is unknown.

Further, the interaction feature between the object and the media may include feature data of at least one dimension, and different feature data may represent different transaction features. For example, if the media is a video, for a video B watched by a user A, an interaction feature between the user A and the video B may be a quantity of transaction times, a total transaction amount, a transaction score determined based on a transaction amount (at least one of a single transaction amount or a total transaction amount), or the like.

In some examples, the computer device may obtain an interaction feature set between the object set and the media set locally or from another device, select, for an object in the object set, media that can be recommended to the object from the media set based on the interaction feature set, and recommend the media to the object.

In one of the embodiments, the historical media transaction records of the objects may be item transaction records of the objects for recommended items corresponding to historical interaction media in at least one transaction platform.

The historical media transaction records of the objects may be item transaction records of the objects for recommended items corresponding to historical interaction media in transaction platforms. For example, if the media is music, the user plays the music in a music application, and the music played by the user has a corresponding recommended item, the historical media transaction record of the user may be an item transaction record of the user for the recommended item in transaction platforms. If the user has not traded for the recommended item in the music application, but the user has traded for the recommended item in another application, the historical media transaction record of the user may be an item transaction record of the user for the recommended item in another application. If the user has traded for the recommended item in the music application, and the user has also traded for the recommended item in another application, the historical media transaction record of the user may be an item transaction record of the user for the recommended item in the music application and another application. In this way, transaction records of transaction platforms are collected to generate an interaction feature between an object and media, so that content richness of the interaction feature can be improved, thereby improving accuracy of a subsequent transaction matching degree calculation, and improving media recommendation effectiveness, recommendation accuracy, and a media conversion rate.

In some examples, the historical media transaction record of the object may be an item transaction record for a recommended item corresponding to the media in an interaction process between the object and the media. That is, the historical media transaction record is an item transaction record generated in a single transaction platform due to an interaction behavior of the object for the media. For example, if the media is music, and the user plays the music in a music application, the historical media transaction record of the user may be a related transaction record of an item recommended to the user in the music application for the played music in a process in which the user plays the music. That is, the media set may include media with which the object has interacted and media with which the object has not interacted, and the media with which the object has interacted may be media that the object has interacted with and traded for. In this way, according to an item transaction record generated due to interaction between a user and media in a single platform, recommended media is determined, through data analysis, from media that has not interacted with the user in the platform, and the recommended media is recommended to the user in the platform, so as to recommend, to the user, media presented in the platform by analyzing a consumption habit, a consumption tendency, and consumption willingness of the user in the single platform, thereby effectively improving recommendation effectiveness, recommendation accuracy, and a media conversion rate in the platform.

Operation S204: Decompose the interaction feature set into an object feature set corresponding to the object set and a media feature set corresponding to the media set.

The object feature set corresponding to the object set includes object features respectively corresponding to objects in the object set. The object feature is a potential feature representation of the object. The interaction feature set is generated based on historical media transaction records of objects in the object set. Therefore, an object feature obtained by decomposing the interaction feature set may reflect a transaction property of the object. For example, the object feature may reflect a transaction preference of the user. The media feature set corresponding to the media set includes media features respectively corresponding to media in the media set. The media feature is a potential feature representation of the media. The media feature may reflect a property of the media.

In some examples, after obtaining the interaction feature set between the object set and the media set, the computer device may perform feature decomposition on the interaction feature set, to obtain an object feature set corresponding to the object set and a media feature set corresponding to the media set.

An interaction feature between some objects in the object set and some media in the media set is unknown. However, with reference to an interaction feature between an object and other media, an object feature of each object in the object set and a media feature of each media in the media set may be obtained through feature decomposition.

In one of the embodiments, the interaction feature set is an interaction matrix, some data in the interaction matrix is known, and some data is unknown. Matrix factorization is performed on the interaction matrix, to obtain two feature matrices. One feature matrix represents a potential feature of each user, and the other feature matrix represents a potential feature of each media.

Operation S206: Determine a target object from the object set, obtain, from the media set, media with which the target object has not interacted as target media, obtain a target object feature of the target object from the object feature set, and obtain target media features of the target media from the media feature set.

The target object may be any object in the object set. The target media is media in the media set with which the target object has not interacted. For example, if the media is a video, the target media may be a video that has not been watched by the target user. If the media is music, the target media may be music that has not been played by the target user. If the media is an article, the target media may be an item that the target user has not browsed.

In some examples, the computer device may select any object from the object set as the target object, and obtain an object feature of the target object from the object feature set corresponding to the object set as the target object feature. The computer device may obtain, from the media set, media that has not interacted with the target object as the target media, and obtain a media feature of the target media from the media feature set corresponding to the media set as the target media features.

For the same target object, there may be at least one piece of target media.

Operation S208: Determine, based on the target object feature and the target media features, transaction matching degrees between the target object and the target media.

In some examples, the target object feature may reflect a transaction property of the target object, the target media features may reflect a potential property of the target media, and the computer device may predict transaction willingness of the target object for the target media based on the target object feature and the target media features, to obtain transaction matching degrees between the target object and the target media. Higher transaction matching degrees between the target object and the target media indicate higher transaction willingness of the target object for the recommended items corresponding to the target media.

In one of the embodiments, feature similarities between the target object feature and the target media features may be calculated as the transaction matching degrees between the target object and the target media. For example, the target object feature and the target media features are feature vectors, and cosine similarities between the target object feature and the target media features may be calculated as the transaction matching degrees between the target object and the target media.

In an embodiment, the target object feature and the target media features may be inputted into a target matching model, and the target matching model outputs transaction matching degrees between the target object and the target media. The target matching model is a trained matching model. The target matching model may be obtained by performing supervised training based on a training sample and a training label corresponding to the training sample. The training sample includes a training object feature corresponding to a training object and a training media feature corresponding to a training media, and the training label is classified into a positive label and a negative label. The positive label represents that the training object has traded, for the interacted training media, for a recommended item corresponding to the training media. The negative label represents that the training object has not traded, for the interacted training media, for a recommended item corresponding to the training media. The training object feature corresponding to the training object may be obtained from the object feature set, and the training media feature corresponding to the training media may be obtained from the media feature set.

Operation S210: Determine, based on the transaction matching degrees, recommended media corresponding to the target object from the target media.

The recommended media corresponding to the target object are target media needing to be recommended to the target object.

In some examples, after determining the transaction matching degrees between the target object and the target media, the computer device may determine, based on the transaction matching degrees, recommended media corresponding to the target object from the target media. For example, target media whose transaction matching degrees are greater than a matching degree threshold are selected as the recommended media; target media whose transaction matching degrees are the maximum are selected as the recommended media; and pieces of target media are sorted in descending order of transaction matching degrees, a recommendation order of the target media is determined according to a sorting result, and target media ranked top are preferentially recommended to the user.

In one of the embodiments, the recommendation in the method of this disclosure may be an active recommendation. When a target user enters a target platform, media with which the target object has not interacted are obtained from the media set in the target platform as target media, transaction matching degrees between the pieces of target media and the target user are separately determined, and recommended media corresponding to the target user are determined from the target media based on the transaction matching degrees. When the target user enters the target platform, the recommended media are actively presented to the target user.

The recommendation in the method of this disclosure may also be a passive recommendation (or may be referred to as search). Search information (such as a search word, a search statement, or a search image) inputted by a target user in a target platform is obtained, and a plurality of media matching the search information are obtained from the media set as candidate media, that is, initial search results are determined first. For example, a plurality of media that are semantically similar to the search information are obtained as the candidate media. Further, media with which the target user has not interacted are obtained from the candidate media as target media, transaction matching degrees between the pieces of target media and the target user are separately determined, and recommended media corresponding to the target user are determined from the target media based on the transaction matching degrees. That is, the initial search results are screened to obtain a final search result. The pieces of recommended media are sorted in descending order of transaction matching degrees, to obtain a recommended media sequence. The recommended media sequence is presented on the target platform to the target user as a final search result.

The target platform may be any platform configured for presenting content. For example, the target platform may be a short video platform, a live broadcast platform, a social platform, or the like. Using a short video platform as an example, media in the short video platform is a short video.

In one of the embodiments, a recommended item matching the recommended media is obtained, and the recommended media and the recommended item are sent to a target terminal corresponding to the target object, so that the target terminal associatively presents the recommended media and the recommended item. The recommended item matching the recommended media may be at least one of an item related to content of the recommended media or an item complementary to the recommended media. The item related to the content of the recommended media may be an item presented, introduced, or used in the recommended media. The item complementary to the recommended media may be an item that can be used in cooperation with the item related to the content of the recommended media. In this way, the recommended media are media having relatively high transaction matching degrees. The recommended media and the recommended item are presented associatively, so that the user can be further attracted to trigger an interaction operation on the recommended media, thereby increasing the media conversion rate of the recommended media, and the user can be further attracted to trigger an interaction operation on the recommended item, thereby increasing the item conversion rate of the recommended item.

The interaction feature set may be updated as required. For example, the interaction feature set may be regularly updated. The latest interaction feature set is decomposed, to obtain the latest object feature set and media feature set. When a transaction matching degree needs to be determined, the latest object feature set and media feature set may be obtained to determine the transaction matching degree.

According to the foregoing media recommendation method, a transaction matching degree obtained by comprehensively analyzing respective features of a target object and target media can reflect a matching degree between the target object and the target media more accurately, and whether to recommend the target media to the target object is determined based on the transaction matching degree, which can effectively improve the effectiveness and accuracy of a media recommendation, thereby implementing a more precise and effective personalized recommendation. Further, the interaction feature set may reflect an interaction and transaction relationship between the user set and the media set. An object feature in the object feature set obtained by decomposing the interaction feature set may reflect a consumption preference of a user. A media feature in the media feature set obtained by decomposing the interaction feature set may reflect a property of media. Consumption willingness of the user for target media with which no interaction is performed is predicted based on the object feature of the target user and the media feature of the target media, to obtain a transaction matching degree. A media recommendation is performed based on the transaction matching degree, so that consumption interest of the target user in recommended media can be improved, thereby improving the effectiveness and accuracy of media recommendations. The improvement in recommendation effectiveness and recommendation accuracy can reduce waste of physical resources required for recommendations, thereby improving utilization of the physical resources. The physical resource herein is, for example, a server resource or a network bandwidth resource.

In an embodiment, the obtaining an interaction feature set between an object set and a media set includes: obtaining historical media transaction records of objects in the object set; determining, based on the historical media transaction records of the objects, item transaction statistics of the objects for corresponding historical interaction media; generating an interaction matrix based on the item transaction statistics of the objects for the respective historical interaction media, a first dimension of the interaction matrix representing the objects in the object set, and a second dimension of the interaction matrix representing the media in the media set; and using the interaction matrix as the interaction feature set between the object set and the media set.

The item transaction statistics of the objects for the corresponding historical interaction media are transaction statistics of the objects for the recommended items corresponding to the historical interaction media. The historical media transaction records of the objects include item transaction records of the objects for recommended items corresponding to at least one piece of historical interaction media. Statistics are collected on item transaction records of a recommended item corresponding to the same historical interaction media in the historical media transaction records, to obtain transaction statistics. For example, the transaction statistics may be a quantity of transaction times, a total transaction amount, an average transaction amount, a transaction frequency, a transaction score, or the like of the recommended item corresponding to the historical interaction media. The transaction score is an index for quantitatively evaluating an item transaction record. The transaction score may be a score calculated based on data such as a quantity of transaction times, a transaction amount, and a quantity of transaction items.

In some examples, the computer device may obtain a historical media transaction record of each object in the object set, generate an interaction matrix based on the historical media transaction record of each object, and use the interaction matrix as an interaction feature set between the object set and the media set.

For the interaction matrix, the item transaction statistics of the object for the corresponding historical interaction media are first determined based on the historical media transaction record of the object. For example, transaction scores of the object for a plurality of historical interaction media are respectively calculated based on the historical media transaction record of the object, and the transaction scores are used as the item transaction statistics, to obtain the item transaction statistics of the object for the plurality of historical interaction media. Then, an interaction matrix is generated based on the item transaction statistics of the objects for the respective historical interaction media. A first dimension of the interaction matrix represents an object in the object set, a second dimension of the interaction matrix represents media in the media set, and a matrix value in the interaction matrix represents item transaction statistics of the object for the media.

If an object has not interacted with a piece of media, item transaction statistics of the object for the media are unknown data. In an interaction matrix, a matrix value located by the object and the media is unknown data.

In the foregoing embodiment, item transaction statistics of the objects for corresponding historical interaction media are determined based on the historical media transaction records of the objects, and the item transaction statistics are quantization of historical media transaction records, to facilitate calculation. An interaction matrix is generated based on the item transaction statistics of the objects for the respective historical interaction media, and the interaction matrix is used as the interaction feature set between the object set and the media set, so that the object feature set and the media feature set can be quickly obtained by performing matrix factorization on the interaction matrix.

In a specific application, the interaction matrix is described by using an example in which the media are videos. Referring to FIG. 3, the interaction matrix is a matrix having m rows and n columns. The rows of the interaction matrix represent users, and there are m users in total. The columns of the interaction matrix represent videos, and there are n videos in total. A matrix value in the interaction matrix may be a payment score determined according to a payment amount of a user for a recommended item of a video. A higher payment amount indicates a higher payment score. A matrix value in the interaction matrix may be determined according to a payment history of a user. If a user has watched no video, a corresponding matrix value is unknown data. Matrix factorization is performed on the interaction matrix by using a matrix factorization algorithm (for example, a singular value factorization algorithm or an alternating least squares method), and the interaction matrix may be factorized into two matrices, being an object feature matrix (that is, the object feature set) and a video feature matrix (that is, the media feature set) respectively. One matrix represents a potential feature of a user, and the other matrix represents a potential feature of a video. These potential features may capture properties of the video preferred by the user. The object feature matrix is a matrix having m rows and k columns. A row of the object feature matrix represents a user, and one row of data represents a potential feature of one user. The video feature matrix is a matrix having k rows and n columns. A column of the video feature matrix represents a video, and one column of data represents a potential feature of one video.

In an embodiment, the generating an interaction matrix based on the item transaction statistics of the objects for the respective historical interaction media includes: obtaining a target protection parameter for the item transaction statistics as a transaction protection parameter; determining a target transaction statistic from the item transaction statistics of the objects for the respective historical interaction media; adding noise data to the target transaction statistic based on the transaction protection parameter, to obtain an encrypted transaction statistic; and generating the interaction matrix based on the encrypted transaction statistic and remaining item transaction statistics.

The transaction protection parameter is a target protection parameter for the item transaction statistics. The target protection parameter is configured for adding noise to data, to protect security of the data and avoid data leakage. The target protection parameter may be a preset protection parameter, or may be a protection parameter obtained by adjusting a preset protection parameter. In addition, for different types of data, target protection parameters may be identical or different.

The target transaction statistic is to-be-protected item transaction statistics. The target transaction statistic may be selected as required. For example, the item transaction statistics may be respectively used as a target transaction statistic; or a part of the item transaction statistics may be randomly selected as a target transaction statistic; or an item transaction statistic corresponding to an object whose object activity level is greater than an activity level threshold may be obtained as the target transaction statistic. An object activity level refers to an activity level of an object in an application. For example, if the media are videos in a video application, an object activity level of an object is an activity level of the object in the video application, and the object activity level may be determined according to data such as a quantity of login times, a use time length, and a transaction amount of the object for the video application. In this way, an object whose object activity level is greater than an activity level threshold is a relatively important object, and the item transaction statistics of the important object for the historical interaction media are used as the target transaction statistic, to protect data security of the important object, avoid data leakage, and avoid loss of the important object due to the data leakage.

The encrypted transaction statistic is obtained by adding noise data to the target transaction statistic according to the transaction protection parameter. The target transaction statistic is sensitive data, and it is difficult for external personnel to learn the original target transaction statistic according to the encrypted transaction statistic, thereby effectively protecting data security of the target transaction statistic.

In some examples, when generating the interaction matrix, to improve data security, the computer device may add noise data to the item transaction statistics to hide real item transaction statistics, and generate the interaction matrix according to the item transaction statistics to which the noise data is added.

First, a target protection parameter for the item transaction statistics is obtained as a transaction protection parameter. A target transaction statistic is determined from item transaction statistics of objects for respective historical interaction media. Noise data is added to the target transaction statistic based on the transaction protection parameter, to obtain an encrypted transaction statistic. For example, a part of the item transaction statistics is selected from the item transaction statistics as the target transaction statistic. The interaction protection parameter includes a value range of the noise data. A piece of noise data is selected from the value range. A sum of the target transaction statistic and the noise data is used as the encrypted transaction statistic. For different target transaction statistics, the same noise data may be selected, or different noise data may be selected. Then, the interaction matrix is generated based on the encrypted transaction statistic and remaining item transaction statistics.

In the foregoing embodiment, when the interaction matrix is generated, noise data is added to the item transaction statistics based on the transaction protection parameter, so that data security of the item transaction statistics can be protected, and data leakage of the item transaction statistics can be avoided.

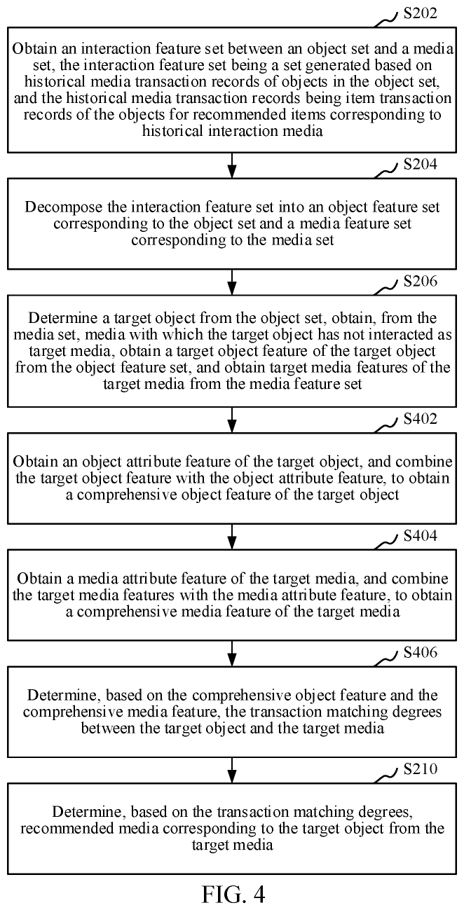

In an embodiment, as shown in FIG. 4, the determining, based on the target object feature and the target media features, transaction matching degrees between the target object and the target media includes:

Operation S402: Obtain an object attribute feature of the target object, and combine the target object feature with the object attribute feature, to obtain a comprehensive object feature of the target object.

Operation S404: Obtain a media attribute feature of the target media, and combine the target media features with the media attribute feature, to obtain a comprehensive media feature of the target media.

Operation S406: Determine, based on the comprehensive object feature and the comprehensive media feature, the transaction matching degrees between the target object and the target media.

The object attribute feature is a feature representation of an object attribute. The object attribute is an attribute of a user, and the object attribute is a description or a summarization of personal information of the user. For example, the object attribute may be an object portrait, and the object portrait is a summarization of and a description of features such as personal information, an interest, and a behavior habit of a user. The media attribute feature is a feature representation of a media attribute. The media attribute is a description or a summarization of media content. For example, the media attribute may be a media title, a media introduction, or a media label.

In some examples, to further improve the accuracy of the transaction matching degree, the computer device may combine the potential feature obtained through feature decomposition with other available metadata, to better capture the relationship between the interest of the user and the media.

The computer device may obtain an object attribute feature of the target object, and combine the target object feature with the object attribute feature, to obtain a comprehensive object feature of the target object. For example, the target object feature and the object attribute feature may be concatenated, to obtain a comprehensive object feature. The computer device may obtain a media attribute feature of the target media, and combine the target media features with the media attribute feature, to obtain a comprehensive media feature of the target media. For example, the target media features and the media attribute feature may be concatenated to obtain a comprehensive media feature. Then, the computer device may predict transaction willingness of the target object for the target media based on the comprehensive object feature and the comprehensive media feature, to obtain transaction matching degrees between the target object and the target media. For example, a feature similarity between the comprehensive object feature and the comprehensive media feature is calculated, to obtain the transaction matching degrees between the target object and the target media.

In one of the embodiments, the comprehensive object feature and the comprehensive media feature are inputted into a target matching model, and the target matching model outputs transaction matching degrees between the target object and the target media. The target matching model is a trained matching model. The target matching model may be obtained by performing supervised training based on a training sample and a training label corresponding to the training sample. The training sample includes a training object feature corresponding to a training object and a training media feature corresponding to a training media, and the training label is classified into a positive label and a negative label. The positive label represents that the training object has traded, for the interacted training media, for a recommended item corresponding to the training media. The negative label represents that the training object has not traded, for the interacted training media, for a recommended item corresponding to the training media. The training object feature corresponding to the training object may be obtained from the object feature set, and the training media feature corresponding to the training media may be obtained from the media feature set. The training object feature corresponding to the training object may alternatively be a comprehensive object feature corresponding to the training object, and the training media feature corresponding to the training media may alternatively be a comprehensive media feature corresponding to the training media.

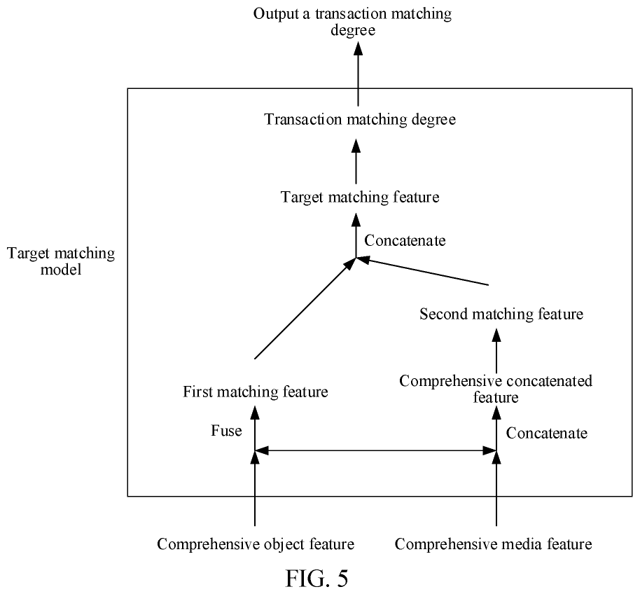

In one of the embodiments, referring to FIG. 5, in the target matching model, the comprehensive object feature and the comprehensive media feature are fused, to obtain a first matching feature, the comprehensive object feature and the comprehensive media feature are concatenated, to obtain a comprehensive concatenated feature, feature extraction is performed on the comprehensive concatenated feature, to obtain a second matching feature, the first matching feature and the second matching feature are concatenated, to obtain a target matching feature, the transaction matching degrees between the target object and the target media are determined based on the target matching feature, and the target matching model outputs the transaction matching degrees between the target object and the target media. In some examples, the comprehensive object feature and the comprehensive media feature may be fused in a fusion manner such as multiplying or adding corresponding elements of the comprehensive object feature and the comprehensive media feature. The comprehensive concatenated feature extraction may be performing feature extraction by using a network layer of the model, for example, by using a network layer such as a convolutional layer or a fully-connected layer. In this way, the target matching model performs full feature interaction on the comprehensive object feature and the comprehensive media feature in a plurality of manners to determine a transaction matching degree, so that accuracy of the transaction matching degree can be improved.

In the foregoing embodiment, the target object feature and the object attribute feature are combined to obtain a comprehensive object feature of the target object, where the comprehensive object feature has richer information. The target media features and the media attribute feature are combined to obtain a comprehensive media feature of the target media, where the comprehensive media feature has richer information. Determining transaction matching degrees between the target object and the target media based on the comprehensive object feature and the comprehensive media feature can effectively improve the accuracy of the transaction matching degree, further improve the accuracy of subsequent media recommendations, and improve the media conversion rate.

In an embodiment, the obtaining an object attribute feature of the target object includes: obtaining a plurality of pieces of attribute data of the target object; determining, based on a data type of target attribute data in the plurality of pieces of attribute data, an attribute protection parameter corresponding to the target attribute data, and adding noise data to the target attribute data based on the attribute protection parameter, to obtain encrypted attribute data; and performing feature extraction on the encrypted attribute data and attribute data other than the target attribute data in the plurality of pieces of attribute data, to obtain the object attribute feature of the target object.

The target object has a plurality of pieces of corresponding attribute data. The target attribute data is to-be-protected attribute data. If inappropriate noise data is added to the data, accuracy of subsequent data processing may be affected. Therefore, corresponding target protection parameters may be respectively set for different types of attribute data, to balance data security and data accuracy.

The attribute protection parameter corresponding to the target attribute data is a target protection parameter that is set for a data type of the target attribute data. The encrypted attribute data is obtained by adding noise data to the target attribute data according to the attribute protection parameter. The target attribute data is sensitive data, and it is difficult for external personnel to learn the original target attribute data according to the encrypted attribute data, thereby effectively protecting data security of the target attribute data.

In some examples, in addition to that the computer device may perform data protection when generating the interaction matrix, the computer device may also perform data protection when generating the object attribute feature, to further protect personal information of the user.

To generate the object attribute feature of the target object, the computer device may obtain a plurality of pieces of attribute data of the target object, and determine the target attribute data from the plurality of pieces of attribute data, for example, randomly obtain attribute data from the plurality of pieces of attribute data as the target attribute data, or obtain, from the plurality of pieces of attribute data, attribute data whose sensitivity is greater than a sensitivity threshold (that is, highly-sensitive attribute data) as the target attribute data. Sensitivity corresponding to each piece of attribute data may be set as required. Then, the computer device determines an attribute protection parameter corresponding to the target attribute data based on the data type of the target attribute data in the plurality of pieces of attribute data, that is, obtains the target protection parameter for the data type of the target attribute data as the attribute protection parameter corresponding to the target attribute data. The computer device adds the noise data to the target attribute data based on the attribute protection parameter, to obtain the encrypted attribute data. For example, the attribute protection parameter includes a value range of the noise data, a piece of noise data is selected from the value range, and a sum of the target attribute data and the noise data is used as the encrypted attribute data. Finally, the computer device performs feature extraction on the encrypted attribute data and attribute data other than the target attribute data in the plurality of pieces of attribute data, to obtain the object attribute feature of the target object. For example, feature engineering is performed on the attribute data, to obtain an object attribute feature; or a feature is extracted by using a machine learning model, to obtain an object attribute feature.

In the foregoing embodiment, when the object attribute feature is generated, noise data is added to the target attribute data based on the attribute protection parameter, so that data security of the target attribute data can be protected, and data leakage of the target attribute data can be avoided.

In an embodiment, the adding noise data to the target attribute data based on the attribute protection parameter, to obtain encrypted attribute data includes: determining a noise distribution based on a noise generation mode and a noise strength in the attribute protection parameter, and sampling noise data from the noise distribution based on the target attribute data; and adding the sampled noise data to the target attribute data, to obtain the encrypted attribute data.

The target protection parameter is configured for adding noise to data, to protect security of the data and avoid data leakage. The target protection parameter may be a preset protection parameter, or may be a protection parameter obtained by adjusting a preset protection parameter.

The target protection parameter includes a noise generation mode and a noise strength. The noise generation mode is a manner of generating noise. For example, the noise generation mode may be a used noise generation algorithm. The noise strength is configured for controlling the strength and the magnitude of noise. The noise distribution may be determined based on the noise generation mode and the noise strength in the target protection parameter. The noise distribution refers to a distribution situation of noise data. For example, the noise distribution may be a noise function in which an input is data to which noise is to be added and an output is noise data. The noise generation mode is configured for determining a statistical property of the noise distribution. For example, the noise conforms to Laplace distribution, Gaussian distribution, or exponential distribution. The noise strength is configured for determining a value range of the noise data.

Corresponding target protection parameters may be respectively set for different types of attribute data. Different target protection parameters may be different noise generation modes, or may be different noise strengths.

In some examples, after determining the target attribute data, the computer device may determine a data type of the target attribute data, and obtain a target protection parameter corresponding to the data type as the attribute protection parameter corresponding to the target attribute data. Then, the computer device determines a noise distribution based on a noise generation mode and a noise strength in the attribute protection parameter, and samples noise data from the noise distribution based on the target attribute data. For example, the noise distribution is a noise function generated based on a noise generation mode and a noise strength. The noise generation mode and the noise strength are components of the noise function. The target attribute data is substituted into the noise function to obtain the noise data. Finally, the computer device adds the sampled noise data to the target attribute data, to obtain the encrypted attribute data.

In the foregoing embodiment, a noise distribution is determined based on a noise generation mode and a noise strength in the attribute protection parameter, and noise data is sampled from the noise distribution based on the target attribute data, so that different target attribute data has respective noise data, and adding the sampled noise data to the target attribute data can implement personalized data protection for the target attribute data, thereby improving data security of the target attribute data.

For a specific process of adding the noise data to the target transaction statistic based on the transaction protection parameter to obtain the encrypted transaction statistic, refer to the specific process of adding the noise data to the target attribute data based on the attribute protection parameter to obtain the encrypted attribute data. Details are not described herein again.

In an embodiment, the noise generation mode may be a differential privacy algorithm, and the noise strength is at least one of a privacy parameter ε or a privacy parameter δ. The differential privacy algorithm may be a Laplace mechanism, an exponential mechanism, imprecise counting, or the like. The privacy parameter ε is configured for quantifying the strength of privacy protection. In some aspects, a relatively small ε means that a higher level of privacy protection is provided, but practicability of some data may be sacrificed. The privacy parameter δ is configured for describing a confidence level of privacy protection. δ being close to 0 indicates that the algorithm provides substantially complete differential privacy protection, but more noise may be introduced.

In an embodiment, the determining, based on the comprehensive object feature and the comprehensive media feature, the transaction matching degrees between the target object and the target media includes: inputting the comprehensive object feature and the comprehensive media feature into a target matching model, for the target matching model to output the transaction matching degrees between the target object and the target media, where the target matching model is obtained by training an initial matching model based on an encrypted training sample and a corresponding training label, and the encrypted training sample is obtained by adding noise data to an original training sample based on the target protection parameter.

The matching model is an artificial intelligence model, and is configured for matching an object with media. Input data of the matching model includes a comprehensive object feature of an object and a comprehensive media feature of media, and output data of the matching model includes a transaction matching degree between the object and the media. The initial matching model is a to-be-trained matching model. The target matching model is a trained matching model.

The comprehensive object feature corresponding to the target object and the comprehensive media feature corresponding to the target media may be determined based on related data including encrypted data. For example, a target object feature in the comprehensive object feature and target media features in the comprehensive media feature may be determined based on an interaction feature set including encrypted data. For another example, the object attribute feature in the comprehensive object feature may be determined based on attribute data including encrypted data. During application of the model, input data of the model may be generated based on the encrypted data. To ensure accuracy of the model, during model training, supervised training is performed on the initial matching model based on the encrypted training sample and the training label corresponding to the encrypted training sample, to obtain the target matching model. The encrypted training sample is inputted into the initial matching model, to obtain a prediction label corresponding to the encrypted training sample, and a model parameter of the initial matching model is adjusted based on a difference between the training label corresponding to the encrypted training sample and the prediction label, until a convergence condition is satisfied, to obtain the target matching model.

The training sample includes a comprehensive object feature corresponding to a training object and a comprehensive media feature corresponding to training media. The training label corresponding to the training sample is configured for indicating an accurate transaction matching degree between the training object and the training media. For example, the training label is classified into a positive label and a negative label. The training media is media with which the training object has interacted. The positive label represents that the training object has traded for a recommended item corresponding to the training media. The negative label represents that the training object has not traded for a recommended item corresponding to the training media. A transaction matching degree corresponding to the positive label is greater than a transaction matching degree corresponding to the negative label.

The encrypted training sample is obtained by adding noise data to the original training sample. The original training sample is a training sample that is original, and the comprehensive object feature and the comprehensive media feature in the original training sample do not include encrypted data. At least one of the comprehensive object feature or the comprehensive media feature in the encrypted training sample is determined based on related data including the encrypted data. The encrypted training sample is obtained by adding noise data to the original training sample based on the target protection parameter. The target protection parameter is configured for adding noise to data, to protect security of the data and avoid data leakage. The target protection parameter includes at least one of the transaction protection parameter or the attribute protection parameter.

In some examples, the computer device may determine a matching degree between the target object and the target media with the help of a feature analysis capability of the artificial intelligence model. The computer device obtains the target matching model, inputs the comprehensive object feature and the comprehensive media feature into the target matching model, and performs data processing on input data by using the target matching model, and the target matching model outputs transaction matching degrees between the target object and the target media.

In the foregoing embodiment, the comprehensive object feature and the comprehensive media feature are inputted into a target matching model, and the target matching model outputs transaction matching degrees between the target object and the target media. The target matching model is obtained through training, has a strong prediction capability, and can output an accurate transaction matching degree. In addition, the target matching model is obtained by training the initial matching model based on the encrypted training sample and the corresponding training label, and can process encrypted input data and output an accurate transaction matching degree.

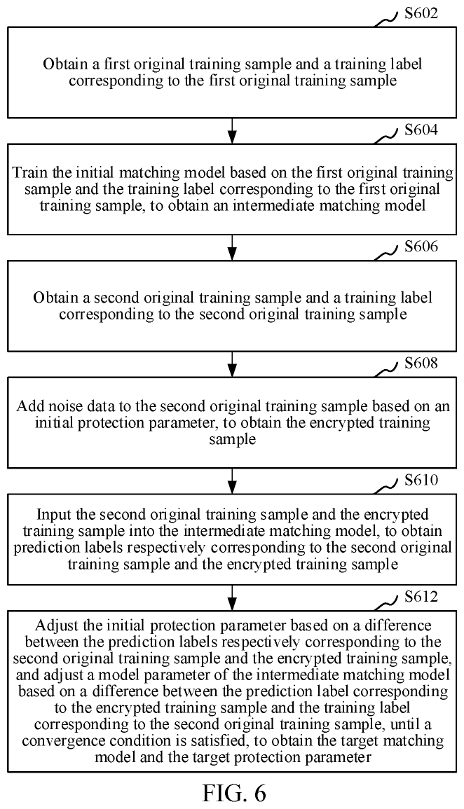

In an embodiment, as shown in FIG. 6, the media recommendation method further includes:

Operation S602: Obtain a first original training sample and a training label corresponding to the first original training sample.

Operation S604: Train the initial matching model based on the first original training sample and the training label corresponding to the first original training sample, to obtain an intermediate matching model.

In some examples, the computer device may obtain a first original training sample and a training label corresponding to the first original training sample, and perform supervised training on the initial matching model based on the first original training sample and the training label corresponding to the first original training sample, to obtain an intermediate matching model, so that the intermediate matching model is accurate to some extent.

Operation S606: Obtain a second original training sample and a training label corresponding to the second original training sample.

Operation S608: Add noise data to the second original training sample based on an initial protection parameter, to obtain the encrypted training sample.

The first original training sample and the second original training sample may be identical original training samples, or may be different original training samples. There may be a plurality of first original training samples, and there may also be a plurality of second original training samples. The initial protection parameter is a protection parameter that is initial. The initial protection parameter may be a preset protection parameter.

In some examples, the intermediate matching model has good performance on a transaction matching degree prediction task for an original training sample. To enable the intermediate matching model to also have good performance on a transaction matching degree prediction task for an encrypted training sample, the computer device may obtain a second original training sample and a training label corresponding to the second original training sample, add noise data to the second original training sample based on an initial protection parameter, to obtain an encrypted training sample, and then further train the intermediate matching model based on the second original training sample, the encrypted training sample, and the training label corresponding to the second original training sample, to obtain a target matching model. The training label corresponding to the second original training sample is also the training label corresponding to the encrypted training sample.

Operation S610: Input the second original training sample and the encrypted training sample into the intermediate matching model, to obtain prediction labels respectively corresponding to the second original training sample and the encrypted training sample.

Operation S612: Adjust the initial protection parameter based on a difference between the prediction labels respectively corresponding to the second original training sample and the encrypted training sample, and adjust a model parameter of the intermediate matching model based on a difference between the prediction label corresponding to the encrypted training sample and the training label corresponding to the second original training sample, until a convergence condition is satisfied, to obtain the target matching model and the target protection parameter.

In some examples, the computer device may input the second original training sample into the intermediate matching model, the intermediate matching model outputs a prediction label corresponding to the second original training sample, the encrypted training sample is inputted into the intermediate matching model, and the intermediate matching model outputs a prediction label corresponding to the encrypted training sample. Although the initial protection parameter can protect data security, the initial protection parameter also affects data processing accuracy. To balance data security and data accuracy, the initial protection parameter and the model parameter may be synchronously adjusted according to related labels of the second original training sample and the encrypted training sample. The computer device adjusts the initial protection parameter based on a difference between the prediction labels respectively corresponding to the second original training sample and the encrypted training sample, so that the prediction label corresponding to the encrypted training sample gradually approaches the prediction label corresponding to the second original training sample, to reduce impact of the protection parameter on a prediction result of the model; and adjusts the model parameter of the intermediate matching model based on a difference between the prediction label corresponding to the encrypted training sample and the training label corresponding to the second original training sample, so that the prediction label corresponding to the encrypted training sample gradually approaches the training label corresponding to the encrypted training sample, thereby enabling the model to gradually have a capability of processing encrypted data. The computer device performs a plurality of rounds of iterative training, and obtains a target matching model and a target protection parameter through a plurality of rounds of protection parameter and model parameter adjustment until a convergence condition is satisfied.

A plurality of second original training samples may be obtained in each round. In one round of training, the first loss is calculated based on a difference between a prediction label corresponding to each second original training sample and a prediction label corresponding to an encrypted training sample of each second original training sample. For example, a prediction label corresponding to an original training sample and a prediction label corresponding to an encrypted training sample of the original training sample are one group, an intra-group difference of each group of data is calculated, a sum of differences of groups is calculated as the first loss, or an average value of differences of groups is calculated as the first loss. The initial protection parameter is adjusted based on the first loss, to obtain an intermediate protection parameter, and the intermediate protection parameter is used as an initial protection parameter in a next round. In one round of training, the second loss is calculated based on a difference between the prediction label and the training label corresponding to each encrypted training sample. For example, the prediction label and the training label corresponding to the encrypted training sample are one group, an intra-group difference of each group of data is calculated, a sum of differences of groups is calculated as the second loss, or an average value of differences of groups is calculated as the second loss. A model parameter of the intermediate matching model is adjusted based on the second loss, to obtain an updated matching model, and the updated matching model is used as an intermediate matching model in a next round.

The convergence condition is a condition for determining whether to end data adjustment. The convergence condition may be that a quantity of rounds of iterative training is greater than a training round threshold, the first loss and the second loss are less than respective loss thresholds, loss change rates of the first loss and the second loss are less than respective change rate thresholds, or the like.

In the foregoing embodiment, the initial matching model is first trained based on the first original training sample and the training label corresponding to the first original training sample, to obtain an intermediate matching model, to enable the intermediate matching model to have a data processing capability with particular accuracy. The second original training sample and the encrypted training sample are inputted into the intermediate matching model, to obtain prediction labels respectively corresponding to the second original training sample and the encrypted training sample, the initial protection parameter is adjusted based on a difference between the prediction labels respectively corresponding to the second original training sample and the encrypted training sample, and a model parameter of the intermediate matching model is adjusted based on a difference between the prediction label corresponding to the encrypted training sample and the training label corresponding to the second original training sample, until a convergence condition is satisfied, to obtain the target matching model and the target protection parameter, so that the target matching model and the target protection parameter can effectively balance prediction accuracy and data security, and accuracy of output data of the model is more reliably ensured while ensuring data security of input data of the model.

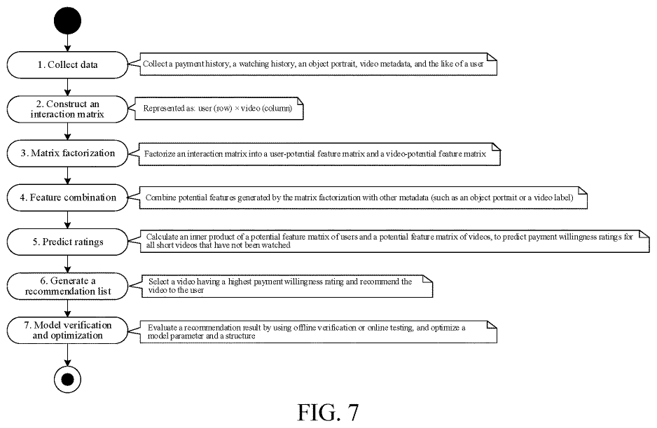

In a specific application, the method of this disclosure is described by using an example in which the media are videos. Referring to FIG. 7, data is first collected. In some examples, a payment history, a watching history, an object portrait (such as an age, a gender, or a geographic location of a user), and video metadata (such as a label, a type, or a publisher of a video) of the user may be collected. Then, an interaction matrix is constructed. The interaction matrix is constructed according to payment histories and watching histories of users. A row of the interaction matrix represents a user, a column represents a video, and values of the matrix may include values in a plurality of dimensions, for example, represents a payment amount of a user for a recommended commodity in a video, a stay time of a user for a video, or a payment rating of a user for a video. Then, matrix factorization is performed on the interaction matrix, and the interaction matrix is factorized into two low-dimensional matrices. One matrix represents potential features of the user, and the other matrix represents potential features of the video. These potential features capture preferences of the user and properties of the video. Further, the potential features generated by the matrix factorization may be combined with other available metadata (such as an object portrait or video metadata), to better capture a relationship between the interest of the user and the video. An inner product of a user-potential feature matrix and a video-potential feature matrix is calculated, to predict, for each user, payment willingness ratings of the user for all short videos that have not been watched. For any user, the predicted payment willingness ratings are sorted, and a video having a highest payment willingness rating is selected and recommended to the user. In addition, payment willingness of the user may be further improved with reference to another commercial policy, such as a recommendation of a coupon to a user, a preferential activity, or an advertisement. Subsequently, the quality and the effect of the recommendation result are evaluated through offline verification or online testing, and the quality and the effect of the recommendation result are evaluated by using an indicator such as an accuracy, a recall rate, or an area under curve (AUC, an area enclosed by an ROC curve and a coordinate axis). A recommendation policy may be continuously adjusted according to the evaluation result to achieve a better recommendation effect.

In this way, valuable information is mined from payment histories of users, and the information is combined with other data features, to generate a more accurate video recommendation, which helps to attract the users to watch the recommended video and improve their payment willingness.

In an embodiment, the media recommendation method further includes: obtaining recommendation feedback data of the target object for the recommended media; determining recommendation quality based on the recommendation feedback data; and updating at least one of the target matching model or the target protection parameter when the recommendation quality is less than a quality threshold.

The recommendation feedback data is a satisfaction degree, an opinion, a suggestion, or a behavior response expressed by the target object after the recommended media is pushed to the target object. For example, the recommendation feedback data may be whether the target object interacts with the recommended media after the recommended media is pushed to the target object.

After the recommended media corresponding to the target object is determined, recommendation feedback data of the target object for the recommended media is obtained, and recommendation quality is determined according to the recommendation feedback data, where the recommendation quality represents recommendation effectiveness of the recommended media. The quality threshold is a threshold for the recommendation quality, and the quality threshold may be set according to an actual requirement.

In some examples, after the recommended media is pushed to the target object, the computer device may obtain the recommendation feedback data of the target object for the recommended media, and analyze the recommendation feedback data, to obtain the recommendation quality. For example, there is a plurality of target objects. Recommendation feedback data of the target objects for respective recommended media is obtained, and statistics on a proportion of positive feedback in the recommendation feedback data are collected, to obtain recommendation quality. The positive feedback indicates that the user is satisfied with the recommended media. For example, if the user opens the recommended media to browse content of the recommended media, the feedback is determined as the positive feedback. Then, the computer device compares the recommendation quality with the quality threshold. If the recommendation quality is greater than or equal to the quality threshold, the recommendation effect meets expectations and the recommendation effect is good. If the recommendation quality is less than the quality threshold, the recommendation effect is poor. If the recommendation quality is less than the quality threshold, the computer device may select to update at least one of the target matching model or the target protection parameter, to improve recommendation quality.

The recommendation quality may be periodically determined. For example, the recommendation quality is determined in each month according to the recommendation feedback data of target objects for respective recommended media within the last month. The recommendation quality may alternatively be determined at any time. For example, when an operation staff or a development staff needs data analysis, recommendation quality is determined by obtaining, based on a requirement of the operation staff or the development staff, recommendation feedback data of a plurality of target objects for respective recommended media.

Updating the target matching model may be adjusting a model parameter of the target matching model, or may be replacing the model. For example, a new training sample and a corresponding training label are obtained, and the target matching model is fine-tuned. Updating the target protection parameter may be adjusting at least one of a noise generation mode or a noise strength in the target protection parameter.

In the foregoing embodiment, recommendation quality is determined based on the recommendation feedback data, and at least one of the target matching model or the target protection parameter is updated when the recommendation quality is less than a quality threshold, so that when a recommendation effect is not good, a recommendation policy can be adjusted and optimized in time, to improve the recommendation effect.

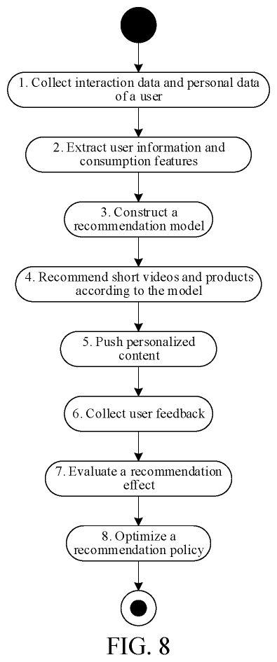

In a specific application, an example in which the media is a short video is used. Referring to FIG. 8, a background server of a short video application collects interaction data and personal data of a user. For example, the interaction data may be short videos watched by the user in the short video application, a payment history, and the like, and the personal data may be registration data of the user in the short video application, user activeness, and the like. The background server extracts user information and a consumption feature from the interaction data and the personal data of the user. For example, the user information may be an object portrait constructed according to the interaction data and the personal data of the user, and the consumption feature may be an object feature obtained by decomposing an interaction matrix. The background server constructs a recommendation model according to the user information and the consumption feature, and recommends short videos and products to the user according to the recommendation model. For example, the recommendation model may be a machine learning model. A comprehensive object feature for the user and a comprehensive video feature for a short video that are obtained according to the user information and the consumption feature are inputted into the recommendation model. The recommendation model outputs consumption matching degrees between the user and short videos. A short video having a relatively high consumption matching degree is obtained from short videos that have not been watched by the user and is recommended to the user. In addition, when the user watches a short video, a product related to the short video is recommended to the user, thereby helping the user to find a product in which the user is interested by using recommended content and improving purchase decision-making of the user. The background server may generate personalized content for the user according to the recommendation model. The personalized content is a personalized recommendation list, and the personalized recommendation list is pushed to a front end of the short video application. The recommendation list includes short videos and related products. Purchase willingness of the user may be stimulated by providing suitable short videos and products. The background server evaluates a recommendation effect by collecting user feedback, and adjusts a recommendation policy in time when the recommendation effect is not good, to more efficiently recommend short videos and products. Indicators such as user satisfaction and a conversion rate may be determined according to user feedback to evaluate a recommendation effect, and consumption willingness of the user in the short video application may be effectively improved by continuously optimizing a recommendation algorithm.

In an embodiment, the determining, based on the target object feature and the target media features, transaction matching degrees between the target object and the target media includes: obtaining the transaction matching degrees between the target object and the target media based on feature similarities between the target object feature and the target media features.

In some examples, the computer device may obtain the transaction matching degrees between the target object and the target media based on feature similarities between the target object feature and the target media features. For example, cosine similarities between the target object feature and the target media features are calculated as the feature similarities between the target object feature and the target media features.

In the foregoing embodiment, by calculating feature similarities between the target object feature and the target media features, the transaction matching degrees between the target object and the target media can be quickly obtained.

In an embodiment, the determining, based on the transaction matching degrees, recommended media corresponding to the target object from the target media includes: obtaining target media whose transaction matching degrees are greater than a matching degree threshold as the recommended media corresponding to the target object; and sorting the pieces of recommended media in descending order of transaction matching degrees, to obtain a recommended media sequence corresponding to the target object.

The matching degree threshold is a threshold for transaction matching degrees, and is configured for screening target media. The matching degree threshold may be set as required.

In some examples, if there is a plurality of pieces of target media, transaction matching degrees between the target object and the pieces of target media may be obtained. The computer device performs media screening based on the matching degree threshold, and obtains target media whose transaction matching degrees are greater than a matching degree threshold as the recommended media corresponding to the target object. If there is a plurality of pieces of recommended media, the computer device may sort the pieces of recommended media in descending order of transaction matching degrees, to obtain a recommended media sequence corresponding to the target object. The recommended media sequence may indicate a recommendation order of the recommended media, and recommended media ranked top are preferentially recommended to the target object. Subsequently, the computer device may push corresponding media to the target terminal corresponding to the target object according to the recommended media sequence.

In the foregoing embodiment, target media whose transaction matching degrees are greater than a matching degree threshold are obtained as the recommended media corresponding to the target object, so that the recommendation effect can be ensured, and the media conversion rate of the recommended media can be increased. The pieces of recommended media are sorted in descending order of transaction matching degrees, to obtain a recommended media sequence corresponding to the target object, and a media recommendation to the target object is performed according to the recommended media sequence, so that the recommendation effect can be ensured, and the media conversion rate of the recommended media can be increased.

In an embodiment, the media recommendation method further includes: obtaining a recommended item matching the recommended media; determining, based on a historical media transaction record of the target object, a promotional activity matching the target object; and associatively pushing the recommended media, the recommended item, and the promotional activity to a target terminal corresponding to the target object, to enable the target terminal to associatively present the recommended media, the recommended item, and the promotional activity.

The recommended item matching the recommended media may be at least one of an item related to content of the recommended media or an item complementary to the recommended media. The item related to the content of the recommended media may be an item presented, introduced, or used in the recommended media. The item complementary to the recommended media may be an item that can be used in cooperation with the item related to the content of the recommended media. For example, if the recommended media is a video in which a smart household product A is introduced, the item related to the recommended media content may be the smart household product A, the item complementary to the recommended media may be a smart household product B that cooperates with the smart household product A. The item complementary to the recommended media is not a smart household product directly presented by the video, but helps to improve the overall performance and convenience of the smart household system.

The promotional activity is an activity configured for providing a discount to an item transaction. For example, the promotional activity may be a coupon, a preferential activity, a discount activity, or the like. A consumption habit of the target object is analyzed based on the historical media transaction record of the target object, and a promotional activity matching the consumption habit is used as a promotional activity matching the target object.

In some examples, the computer device may obtain a recommended item matching the recommended media, and associatively push the recommended media and the recommended item to a target terminal corresponding to the target object, so that the target terminal associatively presents the recommended media and the recommended item. For example, the recommended item and the item transaction entrance corresponding to the recommended item are presented on a media presentation interface of the recommended media.

Further, the computer device may determine, based on a historical media transaction record of the target object, a promotional activity matching the target object. For example, items in the historical media transaction record are classified, and a category coupon corresponding to an item type having a largest quantity of transaction times is obtained as a promotional activity, or a category coupon corresponding to an item type having a largest total transaction amount is obtained, and the category coupon is pushed to the target object; or a discount activity or a preferential activity of an item having a largest quantity of transaction times is obtained as a promotional activity, or a discount activity or a preferential activity of an item having a largest total transaction amount is obtained as a promotional activity, and the discount activity or the preferential activity is pushed to the target object. The computer device associatively pushes the recommended media, the recommended item, and the promotional activity to a target terminal corresponding to the target object, to enable the target terminal to associatively present the recommended media, the recommended item, and the promotional activity. For example, a recommended item and a promotional activity are presented on a media presentation interface of the recommended media. If the user triggers the recommended item, an item details interface may be entered, and an item transaction may be triggered on the item details interface. If the user triggers the promotional activity, a preferential qualification may be received or an activity details interface may be entered, and the preferential qualification may be received on the activity details interface.

In the foregoing embodiment, a recommended item matching the recommended media is obtained, a promotional activity matching the target object is determined based on a historical media transaction record of the target object, and the recommended media, the recommended item, and the promotional activity are associatively pushed to a target terminal corresponding to the target object, so that a personalized recommendation can be implemented. In addition, transaction matching degrees between the recommended media and the target object are relatively high, and the promotional activity is related to the historical media transaction record of the target object. By associatively presenting the recommended media, the recommended item, and the promotional activity, consumption willingness of the target object can be effectively increased, thereby increasing a conversion rate of the recommended media.

In a specific application, the method of this disclosure may be applied to a short video platform. This disclosure provides a short video recommendation solution with reference to a consumption habit of a user, to help an enterprise achieve commercial objectives such as optimization of promotion, improvement of sales, and increase of customer interactions while maintaining user satisfaction and optimizing user experience. The payment history of the user is introduced to the feature of the user, so that a short video recommendation can be more precisely directed to a consumption tendency of the user, consumption willingness of the user is improved, merchants of more consumption types are encouraged to settle in a short video platform, content quality of short videos is improved, and video classification is enriched. In addition, in a process of collecting user data, a privacy protection algorithm is used, to sufficiently protect privacy security of the user.

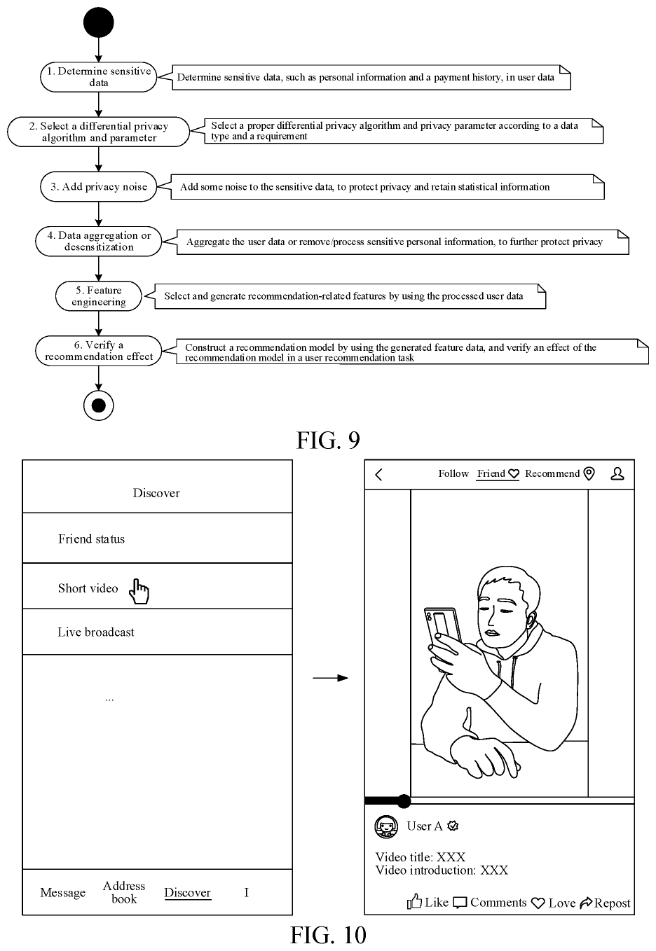

Referring to FIG. 9, a background server of a short video platform obtains user data, and determines sensitive data in the user data. For example, a payment history, personal information, and a watching record in the user data are used as the sensitive data. For the sensitive data, a differential privacy algorithm may be configured to help ensure security of the sensitive data. The background server selects a proper differential privacy algorithm and privacy parameter according to a data type and a requirement of the sensitive data, and adds some noise to the sensitive data according to the selected differential privacy algorithm and privacy parameter, to protect privacy and retain statistical information, thereby balancing privacy protection and data practicality. Further, the background server may aggregate the user data, for example, calculate user activeness or calculate a transaction score according to the user data, and may desensitize the user data, for example, replace a contact manner of the user with a specific character string, or mask some data of a transaction account number of the user. Then, a background processor performs feature engineering on the processed user data, and selects and generates a recommendation-related feature. For example, the background processor creates an interaction matrix based on the user data, performs matrix factorization on the interaction matrix, to obtain an object feature matrix and a short video feature matrix, combines an object feature of the target user in the object feature matrix with an object feature created according to other user data of the target user, to obtain a comprehensive object feature of the target user, obtains a short video that has not been watched by the target user as a target short video, and combines a short video feature of the target short video in the short video feature matrix with a short video feature created according to other short video data of the target short video, to obtain a comprehensive short video feature of the target short video. The background server constructs a recommendation model according to the generated feature data, uses the feature data on which the differential privacy protection has been performed, tests a recommendation effect of the recommendation model, and compares the recommendation effect with a recommendation effect achieved by using original feature data. The model parameter and the differential privacy-related parameter are adjusted to find the best balance between privacy and the recommendation effect. On the premise of protecting privacy security of a user, the model is enabled to learn about consumption habits of different users, for example, an industry or a type of merchant under which a user is more accustomed to performing consumption, so that the short video platform can recommend, to the user, short videos of the merchant that better meet the consumption habit of the user, thereby improving the consumption willingness of the user.

When the user watches the recommended short video, a product related to or complementary to the short video may be recommended to the user, so as to help the user to find a product in which the user is interested by using recommended content, improve purchase decision-making of the user, and improve a conversion rate of the platform. When the user watches the recommended short video, in addition to recommending a product to the user, a consumption habit of the user may be further analyzed according to a payment history of the user, to recommend a coupon, a discount, and a preferential activity matching the consumption habit of the user to the user. For example, the payment history of the user is analyzed to obtain an item type having a largest quantity of transaction times of the user, and a category coupon corresponding to the item type is recommended to the user. These motivation policies may encourage a consumer to generate more consumption behaviors on the short video platform, thereby improving a conversion rate of the platform.

For the method of this disclosure, when user data is collected, security and privacy of the user data can be ensured by using a privacy protection technology. According to a prediction result of the recommendation model, a short video or a product highly related to payment willingness of the user is recommended to the user, thereby improving a possibility that the user purchases a commodity or a service. According to the method of this disclosure, users can find more short videos that meet personal tastes and preferences of the users, thereby increasing the stay time and participation of the users on a platform. The users may be stimulated to make purchases by using precise product promotion and motivation policies such as coupons and preferential activities, thereby improving a conversion rate of the platform.

The method of this disclosure can be applied to a short video platform, and can also be applied to another video platform such as a long video platform or a mixed platform of long videos and short videos, and can be further applied to another platform such as a music platform, a game platform, or a social platform.

Further, various platforms in this disclosure may be application programs, or may be components of application programs. For example, the short video platform may be a short video platform in a social application program. In a specific application, the social application program includes platforms such as a friend status platform configured to present friend statuses, a short video platform configured to present short videos, and a live broadcast platform configured to present live broadcasts. The short video platform may be a short video platform in the social application program. Referring to FIG. 10, a user enters the short video platform in the social application program by triggering an entrance of the short video platform, and the user may browse short videos in the short video platform. By using the method of this disclosure, a short video, a product, or a promotional activity (such as a coupon, a discount, or a preferential activity) related to payment willingness of a user is recommended to the user in the short video platform, so as to effectively improve effectiveness and accuracy of the recommendation, improve consumption willingness of the user, and improve a conversion rate of a video platform.

Although the operations are shown sequentially according to the instructions of the arrows in the flowcharts of the foregoing embodiments, the operations are not necessarily performed sequentially according to the sequence instructed by the arrows. Unless otherwise explicitly specified in this disclosure, the sequence of the operations is not strictly limited, and the operations may be performed in other sequences. Moreover, at least some of the operations in the flowcharts in the foregoing embodiments may include a plurality of operations or a plurality of stages. The operations or stages are not necessarily performed at the same moment but may be performed at different moments. The operations or stages are not necessarily performed sequentially, but may be performed alternately with other operations or at least some of operations or stages of other operations.

Based on the same concept, an embodiment of this disclosure further provides a media recommendation apparatus configured to implement the foregoing media recommendation method. An implementation solution provided by the apparatus for resolving a problem is similar to the implementation solution recorded in the foregoing method. Therefore, for specific limitations on one or more following embodiments of the media recommendation apparatus, refer to the limitations on the foregoing media recommendation method. Details are not described herein again.

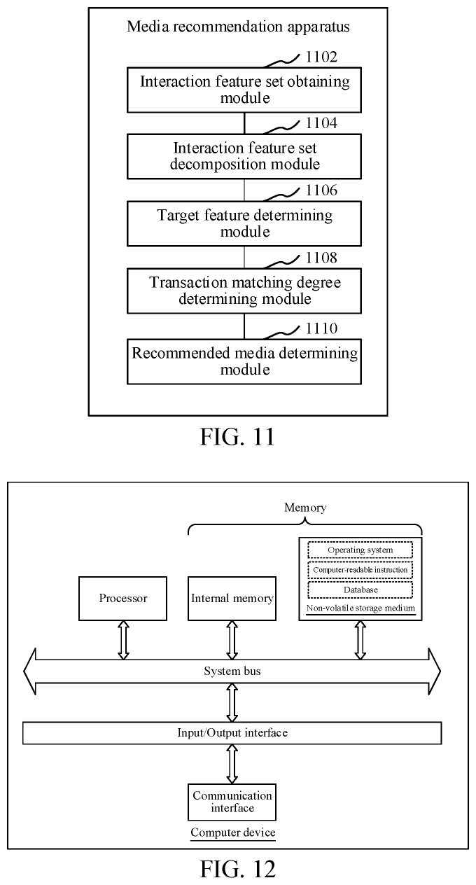

In an embodiment, as shown in FIG. 11, a media recommendation apparatus is provided, including: an interaction feature set obtaining module 1102, an interaction feature set decomposition module 1104, a target feature determining module 1106, a transaction matching degree determining module 1108, and a recommended media determining module 1110.

The interaction feature set obtaining module 1102 is configured to obtain an interaction feature set between an object set and a media set, the interaction feature set being a set generated based on historical media transaction records of objects in the object set, and the historical media transaction records being item transaction records of the objects for recommended items corresponding to historical interaction media.

The interaction feature set decomposition module 1104 is configured to decompose the interaction feature set into an object feature set corresponding to the object set and a media feature set corresponding to the media set.

The target feature determining module 1106 is configured to determine a target object from the object set, obtain, from the media set, media with which the target object has not interacted as target media, obtain a target object feature of the target object from the object feature set, and obtain target media features of the target media from the media feature set.

The transaction matching degree determining module 1108 is configured to determine, based on the target object feature and the target media features, transaction matching degrees between the target object and the target media.

The recommended media determining module 1110 is configured to determine, based on the transaction matching degrees, recommended media corresponding to the target object from the target media.

In an embodiment, the interaction feature set obtaining module 1102 is further configured to: obtain historical media transaction records of objects in the object set; determine, based on the historical media transaction records of the objects, item transaction statistics of the objects for corresponding historical interaction media; generate an interaction matrix based on the item transaction statistics of the objects for the respective historical interaction media, a first dimension of the interaction matrix representing the objects in the object set, and a second dimension of the interaction matrix representing the media in the media set; and use the interaction matrix as the interaction feature set between the object set and the media set.

In an embodiment, the interaction feature set obtaining module 1102 is further configured to: obtain a target protection parameter for the item transaction statistics as a transaction protection parameter; determine a target transaction statistic from the item transaction statistics of the objects for the respective historical interaction media; add noise data to the target transaction statistic based on the transaction protection parameter, to obtain an encrypted transaction statistic; and generate the interaction matrix based on the encrypted transaction statistic and remaining item transaction statistics.

In an embodiment, the interaction feature set obtaining module 1102 is further configured to: obtain, from the item transaction statistics of the objects for the respective historical interaction media, an item transaction statistic corresponding to an object whose object activity level is greater than an activity level threshold as the target transaction statistic.

In an embodiment, the transaction matching degree determining module 1108 is further configured to: obtain an object attribute feature of the target object, and combine the target object feature with the object attribute feature, to obtain a comprehensive object feature of the target object; obtain a media attribute feature of the target media, and combine the target media features with the media attribute feature, to obtain a comprehensive media feature of the target media; and determine, based on the comprehensive object feature and the comprehensive media feature, the transaction matching degrees between the target object and the target media.

In an embodiment, the transaction matching degree determining module 1108 is further configured to: obtain a plurality of pieces of attribute data of the target object; determine, based on a data type of target attribute data in the plurality of pieces of attribute data, an attribute protection parameter corresponding to the target attribute data, and add noise data to the target attribute data based on the attribute protection parameter, to obtain encrypted attribute data; and perform feature extraction on the encrypted attribute data and attribute data other than the target attribute data in the plurality of pieces of attribute data, to obtain the object attribute feature of the target object.

In an embodiment, the transaction matching degree determining module 1108 is further configured to: determine a noise distribution based on a noise generation mode and a noise strength in the attribute protection parameter, and sample noise data from the noise distribution based on the target attribute data; and add the sampled noise data to the target attribute data, to obtain the encrypted attribute data.

In an embodiment, the transaction matching degree determining module 1108 is further configured to: input the comprehensive object feature and the comprehensive media feature into a target matching model, for the target matching model to output the transaction matching degrees between the target object and the target media, where the target matching model is obtained by training an initial matching model based on an encrypted training sample and a corresponding training label, and the encrypted training sample is obtained by adding noise data to an original training sample based on the target protection parameter.

In an embodiment, the media recommendation apparatus is further configured to: obtain a first original training sample and a training label corresponding to the first original training sample; train the initial matching model based on the first original training sample and the training label corresponding to the first original training sample, to obtain an intermediate matching model; obtain a second original training sample and a training label corresponding to the second original training sample; add noise data to the second original training sample based on an initial protection parameter, to obtain the encrypted training sample; input the second original training sample and the encrypted training sample into the intermediate matching model, to obtain prediction labels respectively corresponding to the second original training sample and the encrypted training sample; and adjust the initial protection parameter based on a difference between the prediction labels respectively corresponding to the second original training sample and the encrypted training sample, and adjust a model parameter of the intermediate matching model based on a difference between the prediction label corresponding to the encrypted training sample and the training label corresponding to the second original training sample, until a convergence condition is satisfied, to obtain the target matching model and the target protection parameter.

In an embodiment, the media recommendation apparatus is further configured to: obtain recommendation feedback data of the target object for the recommended media; determine recommendation quality based on the recommendation feedback data; and update at least one of the target matching model or the target protection parameter when the recommendation quality is less than a quality threshold.

In an embodiment, the transaction matching degree determining module 1108 is further configured to: input the comprehensive object feature and the comprehensive media feature into a target matching model; in the target matching model, fuse the comprehensive object feature and the comprehensive media feature, to obtain a first matching feature; concatenate the comprehensive object feature and the comprehensive media feature, to obtain a comprehensive concatenated feature; perform feature extraction on the comprehensive concatenated feature, to obtain a second matching feature; concatenate the first matching feature and the second matching feature, to obtain a target matching feature; and determine the transaction matching degrees between the target object and the target media based on the target matching feature; and the target matching model outputs the transaction matching degrees.

In an embodiment, the transaction matching degree determining module 1108 is further configured to: obtain the transaction matching degrees between the target object and the target media based on feature similarities between the target object feature and the target media features.

In an embodiment, the recommended media determining module 1110 is further configured to: obtain target media whose transaction matching degrees are greater than a matching degree threshold as the recommended media corresponding to the target object; and sort the pieces of recommended media in descending order of transaction matching degrees, to obtain a recommended media sequence corresponding to the target object.

In an embodiment, the recommended media determining module 1110 is further configured to: obtain a recommended item matching the recommended media; associatively push the recommended media and the recommended item to a target terminal corresponding to the target object, to enable the target terminal to associatively present the recommended media and the recommended item.

In an embodiment, the recommended media determining module 1110 is further configured to: obtain a recommended item matching the recommended media; determine, based on a historical media transaction record of the target object, a promotional activity matching the target object; and associatively push the recommended media, the recommended item, and the promotional activity to a target terminal corresponding to the target object, to enable the target terminal to associatively present the recommended media, the recommended item, and the promotional activity.

In an embodiment, the recommended media determining module 1110 is further configured to: obtain at least one of an item related to content of the recommended media or an item complementary to the recommended media, as the recommended item matching the recommended media.

According to the foregoing media recommendation apparatus, the transaction matching degrees obtained by comprehensively analyzing the respective features of the target object and the target media can reflect matching degrees between the target object and the target media more accurately, and whether to recommend the target media to the target object is determined based on the transaction matching degrees, which can effectively improve the effectiveness and accuracy of media recommendations, thereby implementing more precise and effective personalized recommendations. Further, the interaction feature set may reflect an interaction and transaction relationship between the user set and the media set. An object feature in the object feature set obtained by decomposing the interaction feature set may reflect a consumption preference of a user. A media feature in the media feature set obtained by decomposing the interaction feature set may reflect a property of media. Consumption willingness of the user for target media with which no interaction is performed is predicted based on the object feature of the target user and the media feature of the target media, to obtain a transaction matching degree. A media recommendation is performed based on the transaction matching degree, so that consumption interest of the target user in recommended media can be improved, thereby improving the effectiveness and accuracy of media recommendations.

All or some of the modules in the media recommendation apparatus may be implemented by software, hardware, and a combination thereof. The foregoing modules may be built in or independent of a processor of a computer device in a form of hardware, or may be stored in a memory of the computer device in a form of software, for the processor to invoke to perform operations corresponding to the foregoing modules.

In an embodiment, a computer device is provided. The computer device may be a server, and an internal structure diagram thereof may be shown in FIG. 12. The computer device includes a processor, a memory, an input/output (I/O) interface, and a communications interface. The processor, the memory, and the I/O interface are connected via a system bus, and the communication interface is connected to the system bus via the I/O interface. The processor of the computer device is configured to provide computing and control capabilities. The memory of the computer device includes a non-volatile storage medium and an internal memory. The non-volatile storage medium stores an operating system, a computer-readable instruction, and a database. The internal memory provides an environment for running an operating system and computer readable instructions in the non-volatile storage medium. The database of the computer device is configured to store data such as a recommendation model and a protection parameter. The input/output interface of the computer device is configured for exchanging information between the processor and an external device. The communication interface of the computer device is configured to communicate with an external terminal through a network. The computer-readable instructions, when executed by the processor, implement a media recommendation method.

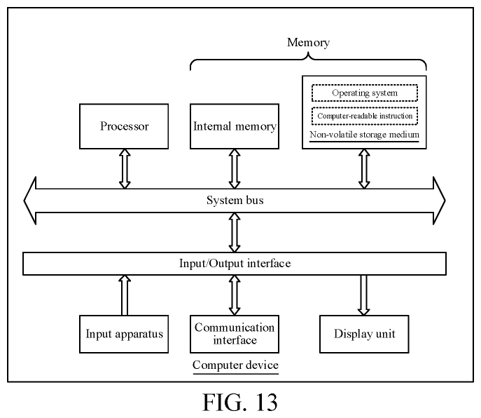

In an embodiment, a computer device is provided. The computer device may be a terminal, and an internal structure diagram thereof may be shown in FIG. 13. The computer device includes a processor, a memory, an input/output (I/O) interface, a communication interface, a display unit, and an input apparatus. The processor, the memory, and the I/O interface are connected through a system bus, and the communication interface, the display unit, and the input apparatus are connected to the system bus through the I/O interface. The processor of the computer device is configured to provide computing and control capabilities. The memory of the computer device includes a non-volatile storage medium and an internal memory. The non-volatile storage medium stores an operating system and computer readable instructions. The internal memory provides an environment for running an operating system and computer readable instructions in the non-volatile storage medium. The input/output interface of the computer device is configured for exchanging information between the processor and an external device. The communication interface of the computer device is configured for wired or wireless communication with an external terminal. The wireless communication may be realized through Wi-Fi, a mobile cellular network, near-field communication (NFC), or other technologies. The computer-readable instructions, when executed by the processor, implement a media recommendation method. The display unit of the computer device is configured to form a visually visible image, and may be a display screen, a projection apparatus, or a virtual reality imaging apparatus. The display screen may be a liquid crystal display screen or an electronic-ink display screen. The input apparatus of the computer device may be a touch layer covering the display screen, or may be a key, a trackball, or a touchpad arranged on a housing of the computer device, or may be an external keyboard, touchpad, mouse, etc.

It is noted that in the structure shown in FIG. 12 or FIG. 13, a block diagram of a partial structure related to the solution in this disclosure is shown, and the figure does not constitute a limitation to the computer device to which the solution in this disclosure is applied. In some examples, the computer device may include more or fewer components than those shown in the figure, or some components may be combined, or a different component deployment may be used.

In an embodiment, a computer device is further provided, including a memory and a processor, the memory having computer-readable instructions stored therein, the processor, when executing the computer-readable instructions, being configured for implementing the operations in the foregoing method embodiments.

In an embodiment, a computer-readable storage medium is provided, and stores computer-readable instructions. The computer-readable instructions, when executed by the processor, perform the operations of the foregoing method embodiments.

In an embodiment, a computer program product is provided. The computer program product includes computer-readable instructions. When the computer-readable instructions are executed by a processor, the operations in the foregoing method embodiments are implemented.

User information (including but not limited to user device information, user personal information, and the like) and data (including but not limited to data configured for analysis, stored data, presented data, and the like) involved in this disclosure are information and data authorized by a user or fully authorized by all parties, and collection, use, and processing of relevant data need to comply with relevant regulations.

It is noted that some or all procedures in the method in the foregoing embodiments may be implemented by a computer-readable instruction instructing related hardware, the computer-readable instructions may be stored in a non-volatile computer readable storage medium, and when the computer-readable instructions are executed, the procedures in the foregoing method embodiments may be implemented. Any reference to a memory, a database, or another medium used in the various embodiments provided herein can include at least one of a non-volatile or a volatile memory. The non-volatile memory may include a Read-Only Memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, or the like. As an illustration rather than a limitation, the RAM is available in various forms, such as a static random-access memory (SRAM) and a dynamic random-access memory (DRAM). A database involved in the embodiments provided in this disclosure may include at least one of a relational database or a non-relational database. The non-relational database may include, but is not limited to, a blockchain-based distributed database, or the like. A processor involved in the embodiments provided in this disclosure may be, but is not limited to, a general-purpose processor, a central processing unit, a graphics processing unit, a digital signal processor, a programmable logic device, a quantum computing-based data processing logic device, or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this description provided that no conflict exists.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of media recommendation, comprising:
obtaining an interaction feature set between an object set and a media set, the interaction feature set being generated based on historical media transaction records of objects in the object set, and the historical media transaction records including item transaction records of the objects on media in the media set;
decomposing the interaction feature set into an object feature set associated with the object set and a media feature set associated with the media set;
obtaining, from the media set and for a target object in the object set, one or more target media that have no interaction with the target object;
obtaining a target object feature of the target object from the object feature set;
obtaining respective target media features of the one or more target media from the media feature set;
determining, based on the target object feature of the target object and the target media features of the one or more target media, respective transaction matching degrees between the target object and the one or more target media; and
determining, based on the transaction matching degrees and from the one or more target media, one or more recommended media to be recommended to the target object.

2. The method according to claim 1, wherein the obtaining the interaction feature set comprises:
obtaining the historical media transaction records of the objects;
determining, based on the historical media transaction records, item transaction statistics of the objects on the media; and
generating an interaction matrix based on the item transaction statistics of the objects on the media, a first dimension of the interaction matrix representing the objects in the object set, and a second dimension of the interaction matrix representing the media in the media set, the interaction matrix being used as the interaction feature set between the object set and the media set.

3. The method according to claim 2, wherein the generating the interaction matrix comprises:
obtaining a target protection parameter for the item transaction statistics as a transaction protection parameter;
determining a target transaction statistic from the item transaction statistics, the item transaction statistics including the target transaction statistic and remaining item transaction statistics;
adding noise data to the target transaction statistic based on the transaction protection parameter, to obtain an encrypted transaction statistic; and
generating the interaction matrix based on the encrypted transaction statistic and the remaining item transaction statistics.

4. The method according to claim 3, wherein the determining the target transaction statistic comprises:
obtaining, from the item transaction statistics, an item transaction statistic of an object whose object activity level is greater than an activity level threshold as the target transaction statistic.

5. The method according to claim 1, wherein the determining the transaction matching degrees comprises:
obtaining an object attribute feature of the target object;
combining the target object feature with the object attribute feature, to obtain a comprehensive object feature of the target object;
obtaining respective media attribute features of the one or more target media;
combining the target media features respectively with the media attribute features, to obtain respective comprehensive media features of the one or more target media; and
determining, based on the comprehensive object feature of the target object and the comprehensive media features of the one or more target media, the transaction matching degrees between the target object and the one or more target media.

6. The method according to claim 5, wherein the obtaining the object attribute feature of the target object comprises:
obtaining a plurality of pieces of attribute data of the target object, the plurality of pieces of attribute data including target attribute data and non-target attribute data;
determining, based on a data type of the target attribute data, an attribute protection parameter for the target attribute data;
adding noise data to the target attribute data based on the attribute protection parameter, to obtain encrypted attribute data; and
performing feature extraction on the encrypted attribute data and the non-target attribute data to obtain the object attribute feature of the target object.

7. The method according to claim 6, wherein the adding noise data to the target attribute data comprises:
determining a noise distribution based on a noise generation mode and a noise strength in the attribute protection parameter;
sampling noise data from the noise distribution based on the target attribute data; and
adding the sampled noise data to the target attribute data, to obtain the encrypted attribute data.

8. The method according to claim 5, wherein the determining the transaction matching degrees comprises:
inputting the comprehensive object feature and the comprehensive media features into a target matching model to cause the target matching model to output the transaction matching degrees between the target object and the one or more target media, wherein the target matching model is obtained by training an initial matching model based on at least an encrypted training sample and a corresponding training label, and the encrypted training sample is obtained by adding noise data to an original training sample based on a target protection parameter.

9. The method according to claim 8, wherein the method further comprises:
obtaining a first original training sample and a first training label of the first original training sample;
training the initial matching model based on the first original training sample and the first training label, to obtain an intermediate matching model;
obtaining a second original training sample and a second training label of the second original training sample;
adding noise data to the second original training sample based on an initial protection parameter, to obtain the encrypted training sample;
inputting the second original training sample and the encrypted training sample into the intermediate matching model, to obtain a first intermediate prediction label for the second original training sample and a second intermediate prediction label for the encrypted training sample; and
adjusting the initial protection parameter and at least a model parameter of the intermediate matching model until a convergence condition is satisfied to obtain the target matching model and the target protection parameter, the initial protection parameter being adjusted based on a difference between the first intermediate prediction label and the second intermediate prediction label, and the model parameter of the intermediate matching model being adjusted based on a difference between the second intermediate prediction label and the second training label.

10. The method according to claim 8, wherein the method further comprises:
obtaining recommendation feedback data of the target object associated with the one or more recommended media;
determining recommendation quality based on the recommendation feedback data; and
updating at least one of the target matching model or the target protection parameter when the recommendation quality is less than a quality threshold.

11. The method according to claim 5, wherein the determining the transaction matching degrees comprises:
inputting the comprehensive object feature of the target object and at least a comprehensive media feature of a target media in the comprehensive media features of the one or more target media into a target matching model to cause the target matching model to:
fuse the comprehensive object feature and a comprehensive media feature, to obtain a first matching feature,
concatenate the comprehensive object feature and the comprehensive media feature, to obtain a comprehensive concatenated feature,
perform feature extraction on the comprehensive concatenated feature, to obtain a second matching feature,
concatenate the first matching feature and the second matching feature, to obtain a target matching feature,
determine a transaction matching degree between the target object and the target media based on the target matching feature, and
output the transaction matching degree.

12. The method according to claim 1, wherein the determining the transaction matching degrees comprises:
obtaining the transaction matching degrees between the target object and the one or more target media based on feature similarities between the target object feature and the target media features.

13. The method according to claim 1, wherein the determining the one or more recommended media comprises:
obtaining the one or more recommended media with respective transaction matching degree greater than a matching degree threshold; and
sorting the one or more recommended media in descending order of transaction matching degrees, to obtain a recommended media sequence for recommending to the target object.

14. The method according to claim 1, wherein the method further comprises:
obtaining a recommended item matching a recommended media in the one or more recommended media; and
pushing the recommended media in association with the recommended item to a target terminal of the target object, to enable the target terminal to present the recommended media in association with the recommended item.

15. The method according to claim 1, wherein the method further comprises:
obtaining a recommended item matching a recommended media in the one or more recommended media;
determining, based on a historical media transaction record of the target object, a promotional activity matching the target object; and
pushing the recommended media and the recommended item in association with the promotional activity to a target terminal of the target object, to enable the target terminal to present the recommended media and the recommended item in association with the promotional activity.

16. The method according to claim 14, wherein the obtaining the recommending item comprises at least one of:
obtaining the recommended item that is related to content of the recommended media; or
obtaining the recommended item that is supplementary to the recommended media.

17. An apparatus for media recommendation, comprising processing circuitry configured to:
obtain an interaction feature set between an object set and a media set, the interaction feature set being generated based on historical media transaction records of objects in the object set, and the historical media transaction records including item transaction records of the objects on media in the media set;
decompose the interaction feature set into an object feature set associated with the object set and a media feature set associated with the media set;
obtain, from the media set and for a target object in the object set, one or more target media that have no interaction with the target object;
obtain a target object feature of the target object from the object feature set;
obtain respective target media features of the one or more target media from the media feature set;
determine, based on the target object feature of the target object and the target media features of the one or more target media, respective transaction matching degrees between the target object and the one or more target media; and
determine, based on the transaction matching degrees and from the one or more target media, one or more recommended media to be recommended to the target object.

18. The apparatus according to claim 17, wherein the processing circuitry is configured to:
obtain the historical media transaction records of the objects;
determine, based on the historical media transaction records, item transaction statistics of the objects on the media; and
generate an interaction matrix based on the item transaction statistics of the objects on the media, a first dimension of the interaction matrix representing the objects in the object set, and a second dimension of the interaction matrix representing the media in the media set, the interaction matrix being used as the interaction feature set between the object set and the media set.

19. The apparatus according to claim 18, wherein the processing circuitry is configured to:
obtain a target protection parameter for the item transaction statistics as a transaction protection parameter;
determine a target transaction statistic from the item transaction statistics, the item transaction statistics including the target transaction statistic and remaining item transaction statistics;
add noise data to the target transaction statistic based on the transaction protection parameter, to obtain an encrypted transaction statistic; and
generate the interaction matrix based on the encrypted transaction statistic and the remaining item transaction statistics.

20. A non-transitory computer-readable storage medium storing instructions which when executed by at least one processor cause the at least one processor to perform:
obtaining an interaction feature set between an object set and a media set, the interaction feature set being generated based on historical media transaction records of objects in the object set, and the historical media transaction records including item transaction records of the objects on media in the media set;
decomposing the interaction feature set into an object feature set associated with the object set and a media feature set associated with the media set;
obtaining, from the media set and for a target object in the object set, one or more target media that have no interaction with the target object;
obtaining a target object feature of the target object from the object feature set;
obtaining respective target media features of the one or more target media from the media feature set;
determining, based on the target object feature of the target object and the target media features of the one or more target media, respective transaction matching degrees between the target object and the one or more target media; and
determining, based on the transaction matching degrees and from the one or more target media, one or more recommended media to be recommended to the target object.
